(19) United States
(12) Patent Application Publication
(10) Pub. No.: US 2007/0034045 A1
(43) Pub. Date: Feb. 15, 2007

(54) Universal transmission

(76) Inventor: Ajamu Zano Hasani Matthews, Curepe (TT)

Correspondence Address: Ajamu Z. H. Matthews;LP # C56 Ramgoolie Trace, Southern Main Road., Curepe, TT

(21) Appl. No.: 11/199,447

(22) Filed: Aug. 9, 2005

(51) Int. Cl. F16H 33/00

(52) U.S. Cl. 74/640

(57) ABSTRACT

Disclosed, is a mechanical energy transmission that can induce power multiplication in any given transmission ratio. It provides a means for obtaining highly desirable transmission effects that are unachievable with the conventional transmission, such as: (I) simultaneous power multiplication and speed multiplication, (II) simultaneous power multiplication and speed retainance or vice versa, (III) power multiplication from a speed reducer transmission ratio, that will be greater in magnitude than if conventional transmission device was applied. It can eliminate limitations of the conventional transmission, such as; (I) the need for variable ratio, (II) the need for a ratio shifting means and (III) power reductions or speed reductions.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field Of The Invention

This invention relates generally to mechanical energy transmissions, more specifically to a mechanical energy transmission that can induce power multiplications in any given transmission ratio.

2. Prior Art

Transmissions are applied in machines to alter the power and speed effects of mechanical energy originating from a particular power source (engines, electric motors etc). They are made up of transmission members such as gears, pulleys, sprockets or traction rollers that are drivingly linked in various transmission ratios. Through their linkage, lever principle is applied to multiply mechanical power from the source. According to lever principle, power multiplications require that a pivot point be closer to an output force point than it is to an input force point. However, the conventional transmission has limitations, which are attributed to its inability to have pivot points closer to output force points than input force points in any given transmission ratio. This is so because it consists of transmission members (gears, pulleys etc.) that rotate about axial pivot point. Therefore it cannot multiply power in any transmission ratio. When in speed multiplier transmission ratio (a larger transmission device drives a smaller one), the pivot point is closer to the input force point than it is to the output force point, and does not satisfy the requirement for power multiplications. This causes power reductions. And in order satisfy the requirement for power multiplications it must be in speed reducer transmission ratio (a smaller transmission device drives a larger one), but in this arrangement speed is reduced. Thus it is impossible for the conventional transmission to induce power multiplications if it is in any given transmission ratio. Wherefore they could not induce transmission effects such as simultaneous multiplications of speed and power or simultaneous speed retainances and power multiplications or vice versa, in one fixed transmission ratio. In one given ratio, the conventional transmission could have only been applied either as a simultaneous power multiplier and speed reducer or a simultaneous speed multiplier and power reducer, which is why; machines such as automobiles and bicycles employ transmissions with several different ratios to make them adaptable to the various drive situations they encounter, like hills and flat land. A further limitation is that the conventional transmission needs to employ ratio-shifting mechanisms in order to access one of these transmission ratios that are necessary to overcome a particular drive situation. Also, these ratio-shifting mechanisms, which vary with transmissions, are complicated. (The method of shifting gives conventional transmissions their respective names, such as manual, automatic or continuously variable.)

The above paragraph outline the general limitations of the conventional transmission, which the universal transmission can eliminate. The following paragraphs, labeled (I), (II) and (III), are detailed descriptions of the gear type conventional transmission, with reference to FIGS. 1 to 4 of the drawings. They are the conventional transmission in the various transmission ratios, respectively. These paragraphs are intended to explain how the axial pivot points of the conventional transmission limits it from being able to induce power multiplications in any given transmission ratio. Also further limitations of the conventional transmission, which the universal transmission can eliminate, are outlined.

(I) Referring to FIGS. 1 and 2, a conventional transmission is in speed multiplier transmission ratio. Here, a casing (11) contains two transmission members (14) that are drivingly linked in a speed multiplier transmission ratio. A geared input shaft (12) drives one of transmission member 14 at its small gear. The large gear of this transmission member drives the other of transmission member 14 at its small gear. The large gear of this second transmission member drives a geared output shaft (13). It is clear that this is speed multiplier transmission ratio between the transmission members (14), since the driving gear is larger than the driven gear. Therefore, each turn of the first of shaft 10 causes the second of shaft 10 to rotate at a faster rate (speed multiplications). And overall, the output shaft rotates faster than the input shaft. As earlier stated, in the conventional transmission the pivot point of each transmission member is axial. Therefore, in such a transmission ratio the pivot points, on lines P, are closer to the input force points, on lines E, than they are to the output force points, on lines L. (Note that in FIG. 2 the pivot point, output force point and input force point are represented by a darkened point on lines P, L and E respectively). And the requirement for power multiplication is not satisfied. Hence power reductions, and in order to obtain power multiplications the conventional transmission has to be linked in a different ratio.

Now, continuous gear train of this sort is formed by adding a third gear, a fourth gear and so on, in the same fashion as illustrated. By continuing such a series, virtually any desired speed ratio can be achieved, with each subsequent shaft rotating faster than the previous one. But each subsequent shaft rotates with less torque than the previous. With such a gear train, thousands of output shaft revolutions can be obtained from a single input shaft revolution. But it has been impossible to fully exploit the continuous speed multiplier gear train for its speed multiplying property because since each subsequent shaft rotates with less torque than the previous, the output or final shaft's torque may be much too weak for the particular mechanical application. Therefore it would be highly desirable to have a transmission that can induce power multiplication in any given transmission ratio it is linked.

(II) Since the conventional transmission cannot induce power multiplications when in speed multiplier transmission ratio it must be linked in another ratio, the speed reducer ratio. In this ratio the central pivot points of its transmission members can be in the position that satisfies the requirements for power multiplications. No drawings have been presented here because; the gear power multiplier arrangement is simply the reverse of a speed multiplier arrangement. Instead of a large gear driving a small gear, a small gear drives a large gear. Therefore each turn of the driving gear shaft causes the driven gear shaft to rotate at a slower rate (speed reductions), and overall an output shaft rotates at a slower rate than an input shaft. But the driven shaft rotates with greater torque (power multiplications) than the driving gear shaft. This is as a result of pivot point being closer to output force point than input force point.

Also, continuous gear train of this sort is formed by adding a third gear, a fourth gear and so on, continuing the series of drivingly linked gears in a similar pattern. By continuing such a series, virtually any desired mechanical advantage can be achieved and the gear train can convert a small input force from a mechanical power source to an extremely large output force on a load. But it has been impossible to fully exploit the continuous speed reducer gear train for its power multiplying property because since each subsequent shaft turns slower than the previous, the output or final shaft's speed may be much too low for the particular mechanical application. Therefore it would be highly desirable to have a transmission that can induce power multiplications in any given transmission ratio.

(III) Referring to FIGS. 3 & 4, a conventional transmission is in speed retainer transmission ratio. A geared input shaft (12) drives the first of gear 14. The first of gear 14 drives the second of gear 14. The second of gear 14 drives an output shaft (13). It is clear that this is speed retainer transmission ratio between the gears (14), since they are of equal circumferences. Therefore each turn of the first of shaft 10 causes the second of shaft 10 to rotate at the same rate (speed retainance). In such a transmission ratio, the distance between the pivot points, on lines P, and the input force points, on lines E, and the distance between the pivot points, on lines P, and the output force points, on lines L, are equal. And this does not satisfy the requirements for power multiplications. (Note that in FIG. 4 the pivot point, output force point and input force point are represented by a darkened point on lines P, L and E respectively). Power is therefore retained. This gear train simply conveys the same speed and power from a source, so its results are similar to using a shaft as a means of mechanical energy conveyance. Therefore it would be highly desirable to have a transmission that can induce power multiplications in any given transmission ratio it is linked.

In short, prior to the universal transmission a speed multiplier transmission ratio was bound to be a power reducer and a power multiplier transmission ratio was bound to be a speed reducer. It was impossible for the transmission to simultaneously increase power and speed or simultaneously retain speed and increase power or vice versa, in one fixed transmission ratio.

### SUMMARY

A main objective of this invention is to provide a mechanical energy transmission that can induce power multiplications in any given transmission ratio. Whereby highly desirable transmission effects, which are unachievable with the conventional transmission, can be obtained. More specifically, effects such as: (I) simultaneous power and speed multiplication is obtainable, when applied in speed multiplier transmission ratio, (II) simultaneous power multiplication and speed retainance is obtainable, when applied in speed retainer transmission ratio, (III) power multiplication from a speed reducer transmission ratio is obtainable, which will be greater in magnitude than if a conventional transmission was applied. It can eliminate limitations of the known transmission, like power or speed reductions, the need for variable ratio and the need for ratio-shifting means, and it provides a new transmission device that will promote new technology in industry. The device comprises transmission member that rotates axially about non-axial, radial pivot point, whereby, in any given transmission ratio pivot point can be closer to the output force point than it is to the input force point, satisfying the requirement for power multiplications.

### BRIEF DESCRIPTION OF THE DRAWINGS

Figures.

FIG. 1 is a cutaway diagrammatic side view of a conventional transmission, wherein transmission members are drivingly linked in speed multiplier transmission ratio.

FIG. 2 is a working schematic view of a conventional transmission, wherein transmission members are drivingly linked in speed multiplier transmission ratio.

FIG. 3 is a cutaway diagrammatic side view of a conventional transmission, wherein transmission members are drivingly linked in speed retainer transmission ratio.

FIG. 4 is a working schematic view of a conventional transmission, wherein transmission members are drivingly linked in a speed retainer transmission ratio.

FIG. 5 is a cutaway diagrammatic side view of a universal transmission, wherein transmission members are drivingly linked in a speed multiplier transmission ratio.

FIG. 6 is a working schematic view of the universal transmission of FIG. 5.

FIG. 7 is a cutaway diagrammatic side view of a universal transmission, wherein transmission members are drivingly linked in speed retainer transmission ratio.

FIG. 8 is a working schematic view of the universal transmission of FIG. 7.

FIG. 9 is an isometric view of parts 2abc and 9ab of the universal transmission of FIG. 5.

FIG. 10 is a cutaway isometric view of parts 2abc and 9ab of the universal transmission of FIG. 5.

FIG. 11 is an isometric view of parts 2abc and 9ab of the universal transmission of FIG. 5, where part 2abc is a partially faded, broken and cutaway, exposing some of the more hidden regions.

FIG. 12 is an exploded isometric view of parts 2abc and 9ab of the universal transmission of FIG. 5, where part 2b is cutaway.

FIG. 13 (inset) is a broken, cutaway isometric view of part 1b of part 9b of the universal transmission of FIG. 5, shown from a different angle.

FIG. 14 is a front view of part 2abc of the universal transmission of FIG. 5.

FIG. 15 is a hind view of part 2abc of the universal transmission of FIG. 5.

FIG. 16 is a rear view of part 2abc of the universal transmission FIG. 5 with hidden lines and where parts 1b and 2c are partially cutaway and broken respectively.

FIG. 17 is a front view of part 2abc of the universal transmission of FIG. 5 with hidden lines and where parts 1a and 2b are partially cutaway and broken respectively.

FIG. 18 is a cutaway side view of part 2abc of the universal transmission of FIG. 5.

FIG. 19 is a side view of part 2abc of the universal transmission device of FIG. 5 with hidden lines.

FIG. 20 is a working schematic view of parts 2abc and 2bcc of the universal transmissions of FIGS. 5 and 7 respectively, driven either at 2a (small gear) or 2c (large gear), showing ideal arc extent of slidable sandwiching contact.

FIG. 21 is a working schematic view of parts 2abc and 2bcc of the universal transmissions of FIGS. 5 and 7 respectively, driven either at 2a (small gear) or 2c (large gear), showing faulty arc extent of slidable sandwiching contact.

### REFERENCE NUMERALS/LETTERS

1a, 1b—casing extensions

2abc—transmission member

2bcc—transmission member

2a—small gear

2b—mid section of transmission member

2c—large gear

3—nuts

4—bearing balls

5—nuts

6—bolts

7a, 7b—bearing ball stoppers

8—bolts

9ab—bearing

9a, 9b—bearings

10—shaft

11—casing

12—input shaft

13—output shaft

### DETAILED DESCRIPTION

### Preferred Embodiment

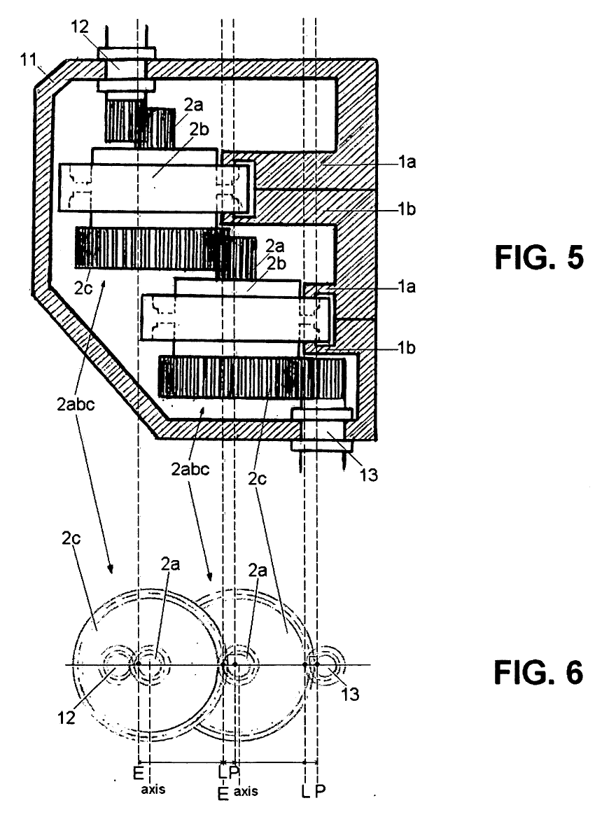

The universal transmission will now be discussed in more detail with reference to FIGS. 5 & 6, 9 to 21. This embodiment illustrates a gear type universal transmission speed multiplier transmission ratio. Here, FIG. 5 is encasement (11) containing two transmission members (2abc) that are drivingly linked in a speed multiplier transmission ratio. A geared input shaft (12) drives one of transmission member 2abc at its small gear (2a). The large gear of this transmission member drives the other of transmission member 2abc at its small gear (2a). The large gear of the second of transmission member 2abc drives a geared output shaft (13). It is clear that there is speed multiplier transmission ratio between the transmission members (2ab), since the driving gear (2b) is larger than the driven gear (2a). So, each complete turn of the input shaft would result in more than one turn of the output shaft (speed multiplication). In contrast to the conventional transmission, the universal transmission comprises transmission member that rotate about non-axial, radial pivot point, allowing pivot points, on lines P, to be closer to output force points, on lines L, than they are to input force points, on lines E, satisfying the requirement for power multiplications. (Note that in FIG. 6 the pivot point, output force point and input force point are represented by a darkened point on lines P, L and E respectively). Therefore in contrast to the conventional transmission, the universal transmission induces simultaneous power and speed multiplications.

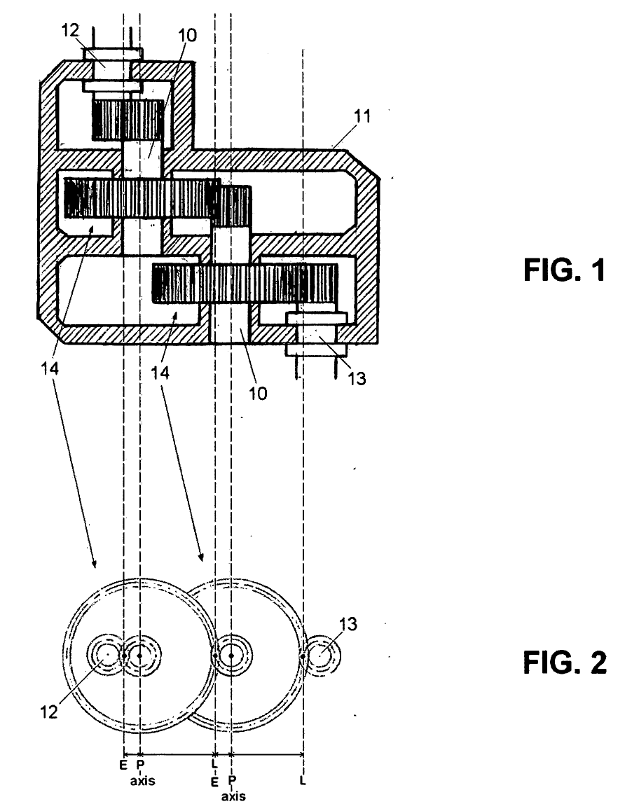

Compare this transmission with the conventional transmission of FIGS. 1 & 2, wherein transmission members are drivingly linked in the same ratio and manner as this one.

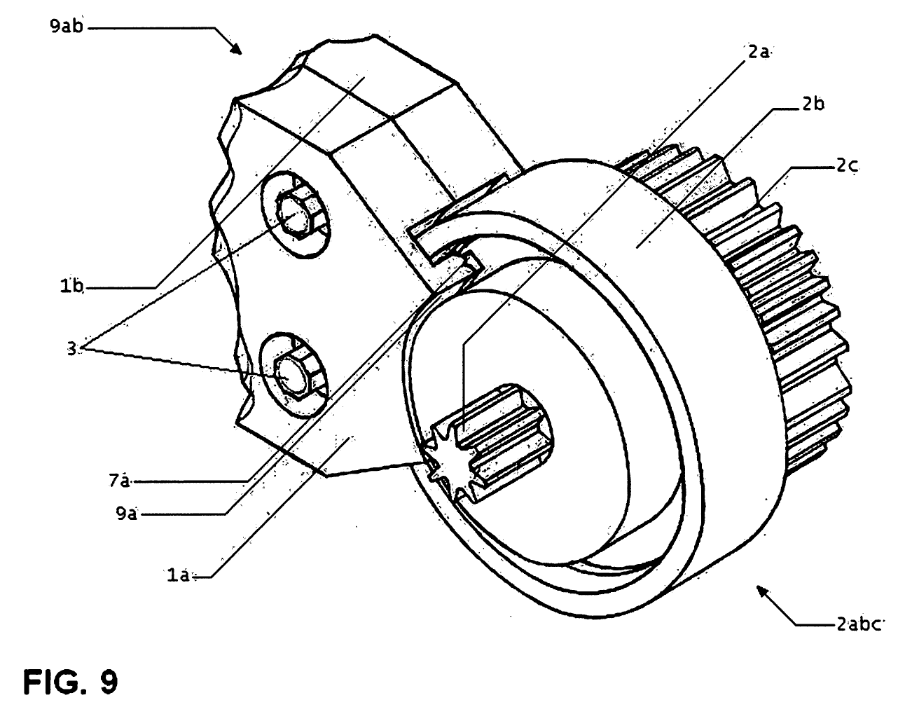

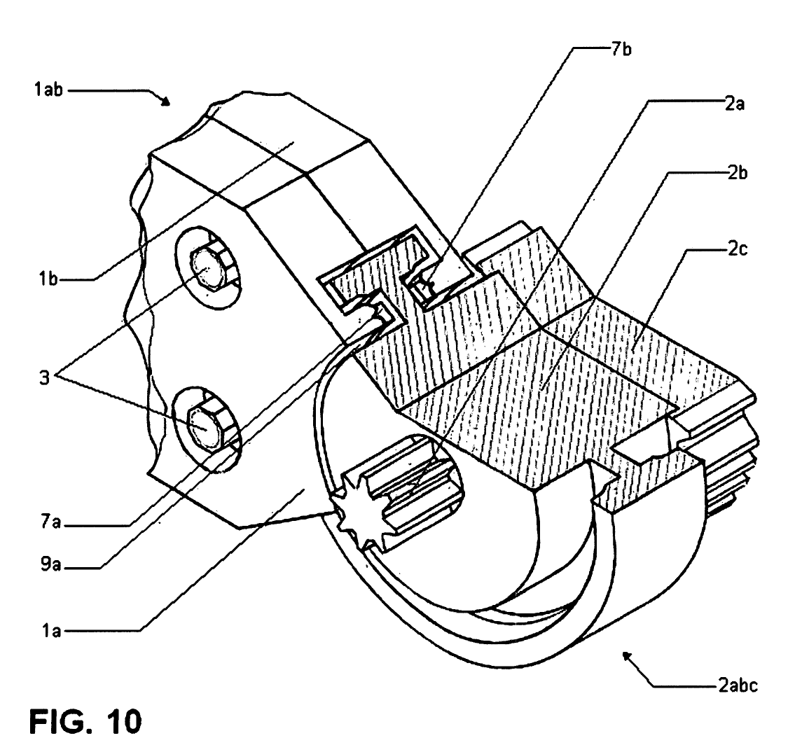

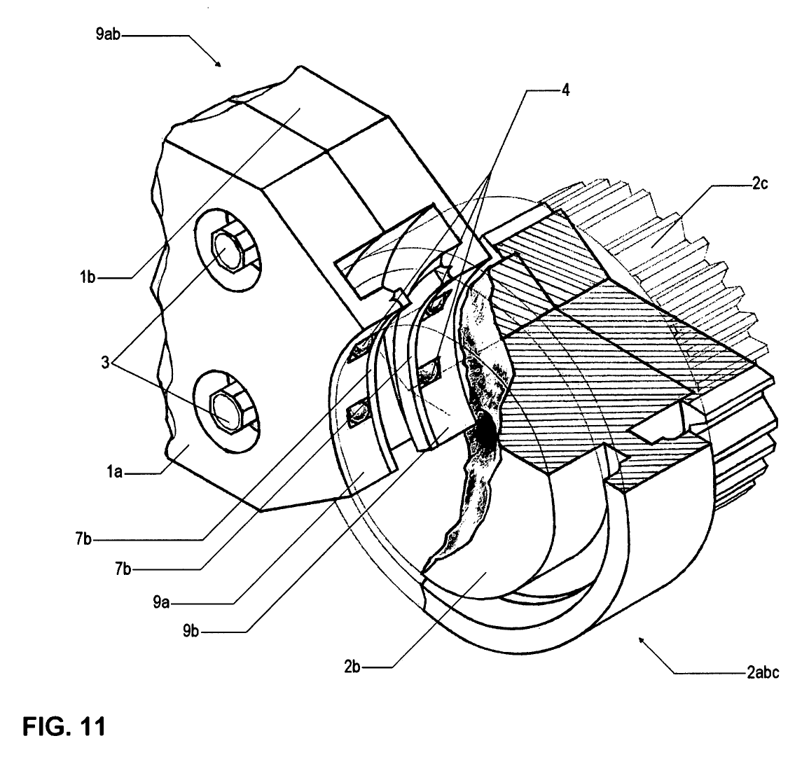

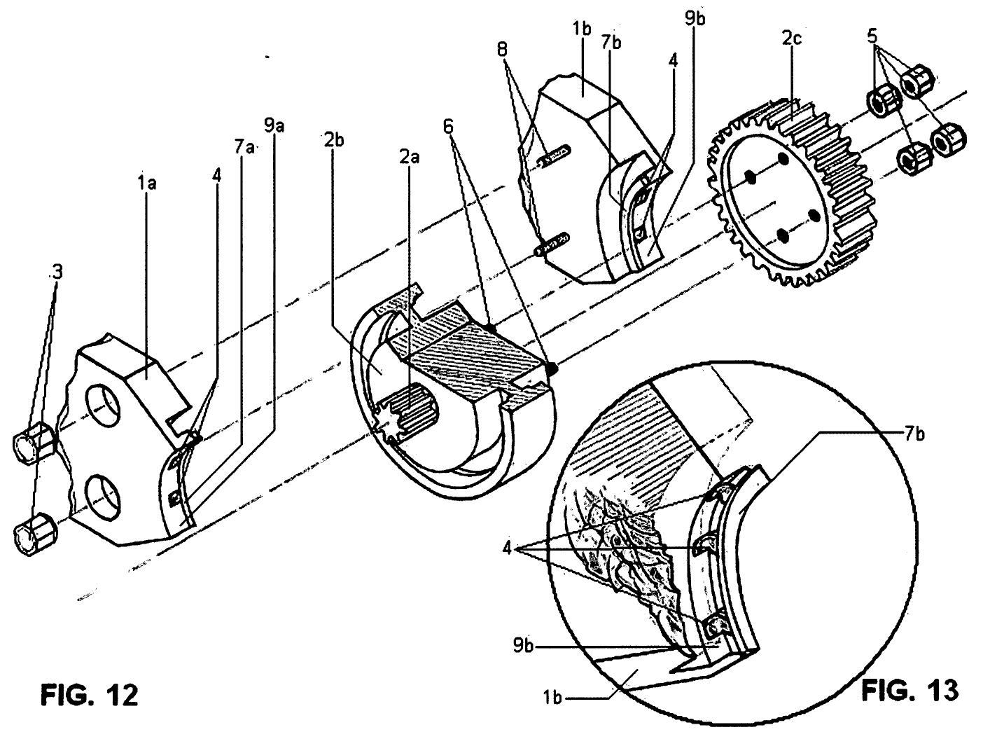

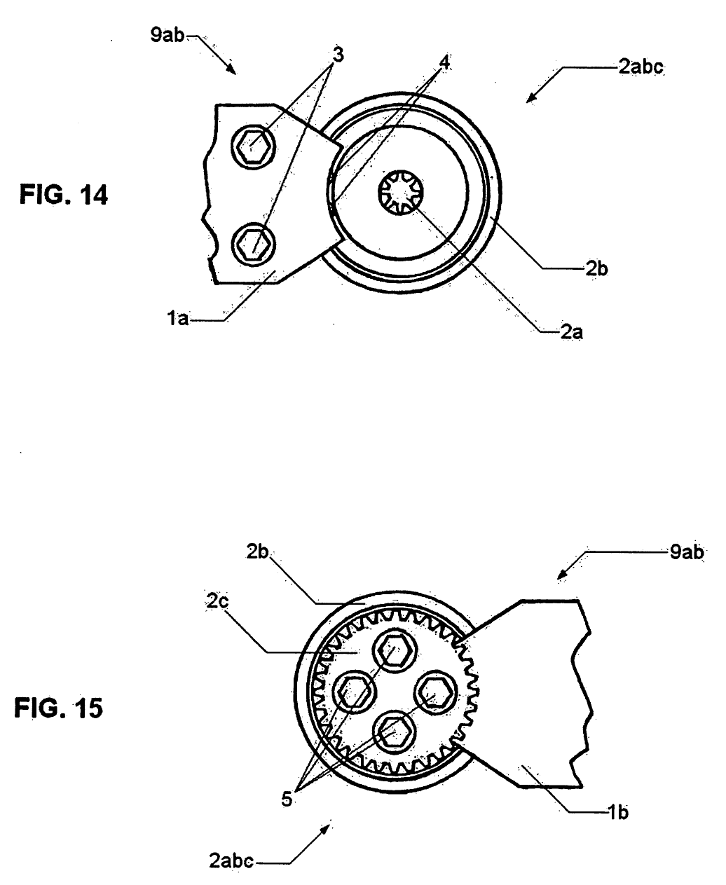

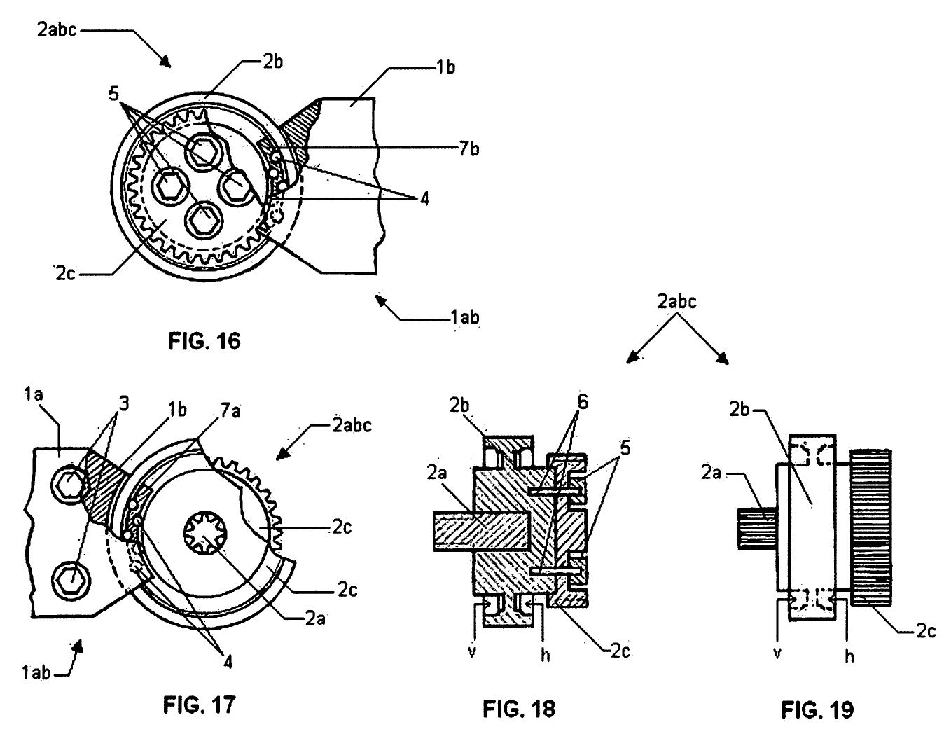

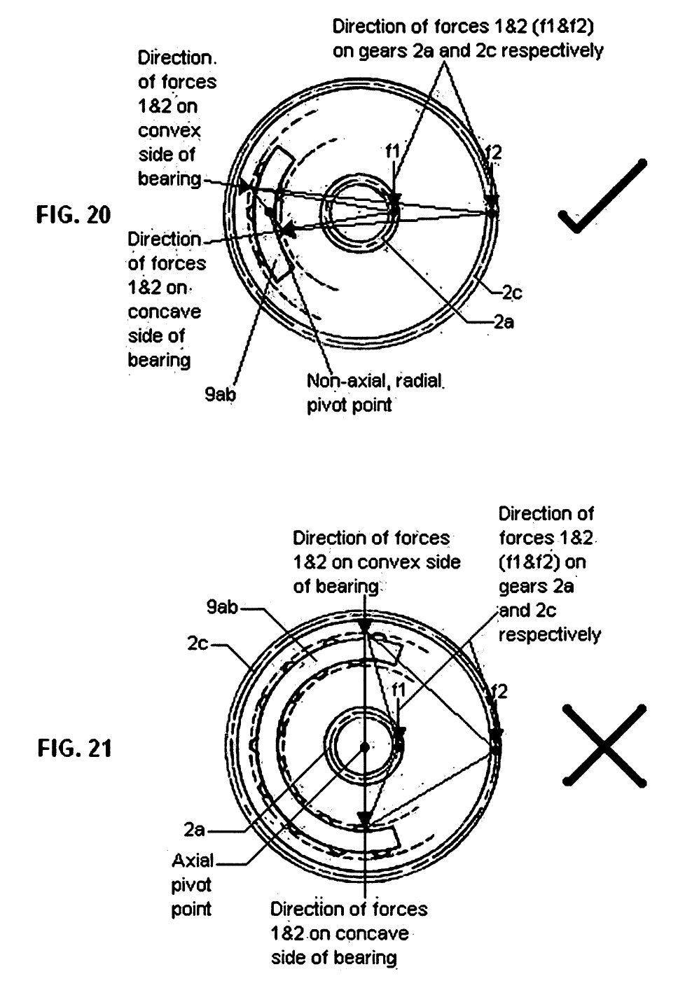

Referring now to FIGS. 9-19, parts 2abc and 9ab of this embodiment are illustrated in detail. 2abc is the rotary transmission member and 9ab is its bearing. As we go along, we will see how these parts are compatibly shaped and assembled to form an assemblage wherein rotary transmission member rotate axially, but about non- axial, radial pivot point. It will become clear that, unlike the conventional transmission, the universal transmission is one wherein a pivot point can be placed anywhere along the diameter of its transmission members. As clearly illustrated in FIGS. 9, 10, 12, 17, 18 and 19, the transmission member (2abc) has a midsection (2b) unto which two gears of varying circumferences are coaxially fixed; a small gear (2a) permanently fitted to the front and a large gear (2c) bolted to the back by nuts and bolts (5 & 6 respectively). Also at the front and back of the midsection (2b) is a groove running annularly and coaxially in them. These grooves are labeled v and h in FIGS. 18 and 19. The bearing (9ab), as clearly illustrated in FIGS. 11, 12 and 13 has two parts, 9a and 9b, which is each depicted on the casing extensions 1a and 1b respectively. These bearings (9a & 9b) are convex-o-concavely shaped, meaning that they each have a convexed and a concaved surface. The bearings contain bearing balls (4), which are prevented from falling out by stoppers (7a & 7b ). Referring now to the assembled figures, more particularly to FIGS. 9 and 10, observe that when assembled, the bearings (9a & 9b) supportingly and slidably fit into the grooves of the midsection (2b), supporting the transmission member from a non-axial or non-central position. The casing extensions (1a & 1b ) are held together by nuts and bolts (3 & 8 respectively). The convex-o-concaved bearing ball surfaces make contact with the grooves' annular contact surfaces in a slidable sandwiching. Note that this slidable sandwiching is through an arc extent, which is such that non-axial, radial pivot point is allowed. FIG. 20 illustrates such ideal arc extent of the slidable sandwiching. If the slidable sandwiching was somewhere like too much beyond half the circumference of the grooves the pivot point will be axial just as in the conventional transmission and it would be impossible to induce power multiplications in any given transmission ratio. FIG. 21 illustrates such faulty arc extent, which should be avoided. The bearings' convex surfaces make contact with the grooves' inwardly curved surfaces while its' concave surfaces make contact with the grooves' outwardly curved surfaces. It is also visible that the grooves' inwardly curved surfaces are notched to prevent the transmission member (2abc) from rotating unsteadily back and forth during rotation.

For maximum leverage or power from the transmission members (2abc), mechanical energy is conveyed as illustrated in FIG. 6, at points substantially perpendicular to the pivot line (P).

Note that in FIGS. 20 and 21 the transmission device is illustrated as being simultaneously driven at both the small and the large gear (2a & 2c respectively), but in practice it is driven either at the small gear (2a) or the large gear (2c).

### Alternative Embodiment

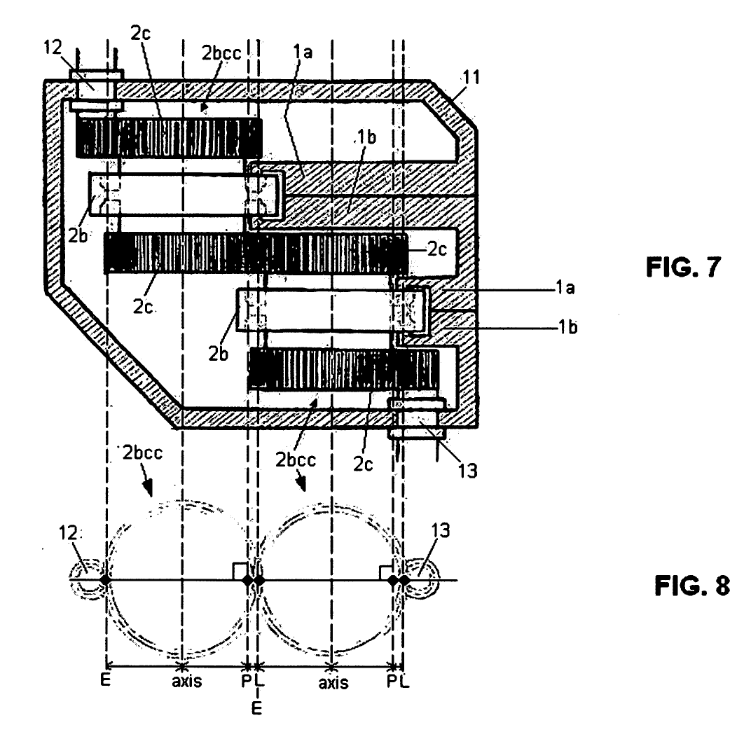

Consider now a gear type universal transmission that is linked in a speed retainer transmission ratio. FIG. 7 & 8 is an encasement (11) containing two transmission members (2bcc) that are drivingly linked in speed retainer transmission ratio. A geared input shaft (12) drives one of transmission member 2bcc. This transmission member drives the other of transmission member 2bcc. The second of transmission member 2bcc drives a geared output shaft (13). It is clear that this is speed retainer transmission between the transmission members (2bcc), since the driving gear and the driven gear are of equal circumferences. So, each complete turn of the input shaft would result in one turn of the output shaft (speed retainance). In contrast to the conventional transmission, the universal transmission comprises of transmission member that rotate about non-axial, radial pivot point, allowing pivot points, on lines P, to be closer to output force points, on lines L, than they are to input force points, on lines E, satisfying the requirement for power multiplications. (Note that in FIG. 8 the pivot point, output force point and input force point are represented by a darkened point on lines P, L and E respectively). Therefore in contrast to the conventional speed transmission, the universal transmission can induce simultaneous power multiplications and speed retainances.

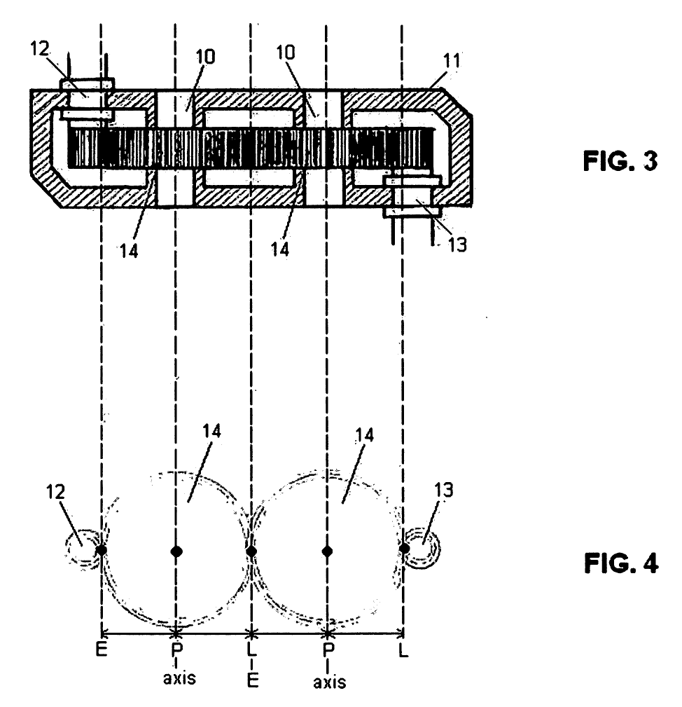

Compare this transmission with the conventional transmission of FIGS. 3 & 4, wherein transmission members are drivingly linked in the same ratio and manner as this one.

Note that the transmission members (2bcc) of this particular embodiment are also pivotably supported in the same manner as that of the preferred embodiment.

For maximum leverage or power from the transmission members (2bcc), mechanical energy is conveyed as illustrated in FIG. 8, at points substantially perpendicular to the pivot line (P).

Operation (Application of the Universal Transmission Device)

The universal transmission is suitable for mechanical operations where there is a desire to:
(I) Simultaneously multiply power and speed effects of mechanical energy from a particular power source.
(II) Multiply power without affecting the speed effect of mechanical energy.
(III) Induce high power multiplications from small transmission enclosures.
(IV) Induce high speed multiplications from small transmission enclosures.

### CONCLUSION, RAMIFICATIONS AND SCOPE

The invention should not be construed as only constructible as it appears in the illustrations and corresponding texts. These are just mere examples of some embodiments that have been presented to help the reader understand the invention. It follows then that the universal transmission can be practiced in different ways. For examples:
Although spur gear has been illustrated as transmission member, the universal transmission can be comprised of any type of transmission member, including pulleys, traction rollers and sprockets.
Although slidable sandwiching as illustrated is depicted as the pivot means for allowing transmission member, axial rotation about a non-axial, radial pivot point, any other pivot means that allows for this can be used, including the use of transmission member.
Although the universal transmission has been only been illustrated in speed multiplier and speed retainer transmission ratio, it can also be practiced in speed reducer transmission ratio, to obtain power multiplication that will be greater in magnitude than if conventional transmission device was applied.

It follows then that it is by the application of a transmission, wherein transmission member rotates axially about non-axial, radial pivot point, that power multiplications from any given transmission ratio is made possible. In contrast to the conventional transmission, the universal transmission makes it possible to: (I) obtain power multiplication in tandem with speed multiplication, (II) retain speed while power is multiplied or vice versa, (III) obtain power multiplication that will be greater in magnitude than if a conventional transmission was applied. Also, other improved transmission effects with the use of this device may become apparent from studying this document.

1. A transmission that can induce power multiplications in any given transmission ratio, comprising:
(a) drivingly linked transmission members, whereby mechanical energy is conveyable and the magnitude of its power and speed effects can be altered.
(b) at least one transmission member that rotates about non-axial, radial pivot point,
whereby in any given transmission ratio, pivot point can be closer to output force point than input force point, so that: (I) simultaneous power multiplications and speed multiplications are obtainable, when in speed multiplier transmission ratio, (II) simultaneous power multiplications and speed retainances are obtainable, when in speed retainer transmission ratio, (III) power multiplications from speed reducer transmission ratio are obtainable, which will be greater in magnitude than if conventional transmission was applied.

2. The transmission members of claim 1, which are gears.
